(19) United States
(12) Patent Application Publication
(10) Pub. No.: US 2024/0422159 A1
(43) Pub. Date: Dec. 19, 2024

(54) METHODS AND APPARATUS TO MANAGE CONFIGURATION ASSETS FOR NETWORK DEVICES

(71) Applicants: Abhijeet Ashok Kolekar, Portland, OR (US); Yi Zhang, San Jose, CA (US); Srikathyayani Srikanteswara, Portland, OR (US); Dario Sabella, Gassino Torinese (IT)

(72) Inventors: Abhijeet Ashok Kolekar, Portland, OR (US); Yi Zhang, San Jose, CA (US); Srikathyayani Srikanteswara, Portland, OR (US); Dario Sabella, Gassino Torinese (IT)

(21) Appl. No.: 18/821,731

(22) Filed: Aug. 30, 2024

(51) Int. Cl. H04L 9/40; H04L 9/32; H04L 41/5003

(52) U.S. Cl. CPC H04L 63/101; H04L 9/3221; H04L 41/5003

(57) ABSTRACT

An example method includes, based on a request from the third-party entity to join the edge network, initiating a Zero-Knowledge Proof (ZKP) protocol by generating a common reference string (CRS) to establish public parameters within the edge network; transmitting the CRS to the third-party entity and an authorization server; obtaining an authorization of the third-party entity from the authorization server, the authorization server authenticating the third-party entity based on a ZKP proof constructed by the third-party entity using the CRS and a private credential of the third-party entity; authorizing the third-party entity to join the edge network based on the authorization; and deploying a smart contract on a distributed ledger, wherein the smart contract specifies conditions under which the third-party entity is granted access to the edge network, and wherein the distributed ledger records transactions related to access permissions of the third-party entity.

### BACKGROUND

Computing environments (e.g., an edge environment, a cloud environment, a distributed network, a datacenter, an Edge, Fog, multi-access edge computing (MEC), or Internet of Things (IoT) network) enable a first device to access to services (e.g., execution of one or more computing tasks, execution of a machine learning model using input data, access to data, etc.) associated with a difference device within the network. Edge environments may include infrastructure, such as an edge platform, that is connected to cloud infrastructure, endpoint devices, and/or additional edge infrastructure via networks, such as the Internet. Edge platforms may be closer in proximity to endpoint devices than cloud infrastructure, such as centralized servers.

### BRIEF DESCRIPTION OF THE DRAWINGS

FIG. 1 is an example environment including servers and/or devices to enhance authentication and/or authorization in a network.

FIG. 2 is a flowchart representative of example machine-readable instructions and/or operations that may be executed, instantiated, and/or performed by programmable circuitry to implement the system of FIG. 1.

FIG. 3 is a flowchart representative of example machine-readable instructions and/or operations that may be executed, instantiated, and/or performed by programmable circuitry to implement the system of FIG. 1.

FIG. 4 is a flowchart representative of example machine-readable instructions and/or operations that may be executed, instantiated, and/or performed by programmable circuitry to implement the system of FIG. 1.

FIG. 5 is a block diagram of an example processor platform including programmable circuitry structured to execute, instantiate, and/or perform the computer readable instructions and/or perform the example operations of FIGS. 2-4 to implement at least one of the system server, the resource owner processing device, the authorization server, the resource requesting processing device, the blockchain platform server, and/or the machine learning implementation processing device of FIG. 1

FIG. 6 is a block diagram of an example software/firmware/instructions distribution platform (e.g., one or more servers) to distribute software, instructions, and/or firmware (e.g., corresponding to the example machine-readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In some applications of distributed networks, a resource owner can utilize a computing device and/or edge-based device that hosts resources that can be used and/or accessed by other devices in the network. For example, a user of a webcam can grant access to the images, video, and/or audio generated by the webcam to another device in a network (e.g., a cell phone). However, to ensure property security and/or privacy, the resource owner and/or an application requesting access to a resource may need to be authenticated and/or authorized.

Traditional authentication and authorization mechanisms between Resource Owners and a device implementing authorization functionality (e.g., a confidential consortium framework (CCF)) within a network lack the flexibility and granularity needed to meet privacy preferences in dynamic edge computing environments. Accordingly, examples disclosed herein authenticate identities and manage permissions for applications accessing services and/or resources (e.g., service APIs), including dynamically granting, adjusting, and/or revoking authorizations for specific applications and ensuring that access to sensitive resources is sufficiently controlled.

Examples disclosed herein create an enhanced authentication and authorization system capable of distinguishing between client (REST client) and resource owners, dynamically manage access permissions, and securely handle consent in edge computing environments. Examples disclosed herein provide secure access to applications and/or data of a resource owner to requesting devices in the edge environment, which varies depending on contextual factors such as the user's location, time of access, security posture of the user's device, and observed user behavior.

Examples disclosed herein utilize zero-knowledge proofs (ZKP) (e.g., zero knowledge succinct non-interactive argument of knowledge (Zk-SNARKs) proofs) to provide privacy-preserving authentication to ensure that the piracy of resource owners is maintained without comprising security. Additionally, examples disclosed herein employ smart contracts for dynamic consent. For example, examples disclosed herein employ smart contracts on a distributed ledger, such as a blockchain, to manage consent and authorization dynamically, allowing for real-time adjustment to permissions based on predefined rules. Additionally, examples disclosed herein implement a context-aware dynamic access control systems (e.g., CADACS) that leverage machine learning to analyze contextual data of a requesting application with established access patterns and behaviors, adjusting application permissions in real-time based on the context of each access request.

Examples disclosed herein address challenges of edge computing, where more flexible and granular access controls are desired due to the dynamic nature of user environments and contexts. Unlike traditional systems that may be overly permissive or restrictive, this system dynamically adjusts permissions based on real-time analysis of contextual information, enhancing security and user experience in edge environments.

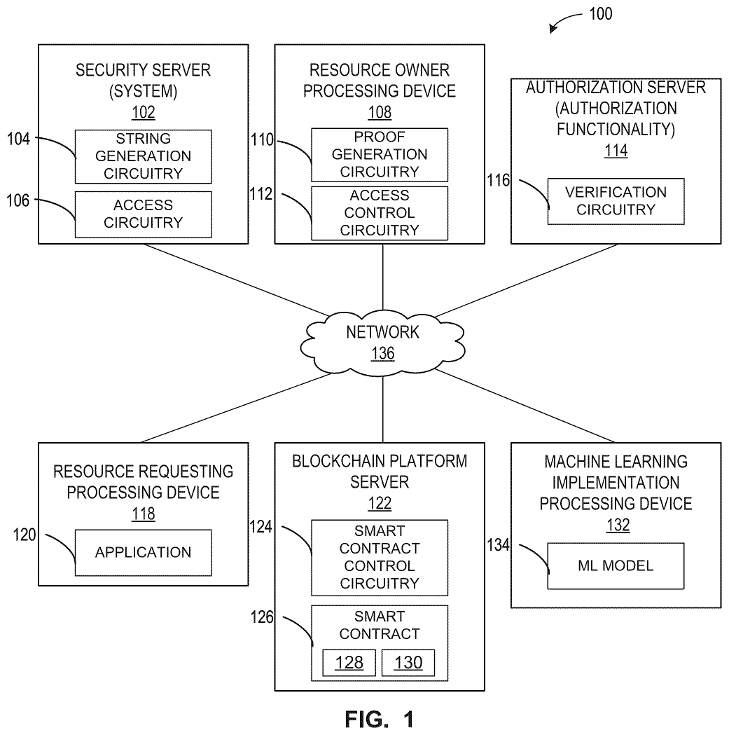

FIG. 1 is an example environment 100 that includes an example security server 102 including example string generation circuitry 104 and example access circuitry 106, an example resource owner processing device 108 including example proof generation circuitry 110 and example access control circuitry 112, an example authorization server 114 including verification circuitry 116, example resource requesting processing device 118 including an example application 120, an example blockchain platform server 122 including example smart control circuitry 124, an example smart contract 126, example processing circuitry 128, and example memory 130, an example machine learning implementation processing device 132 including a machine learning model 134, and an example network 136. In some examples, one or more of the security server 102, the authorization server 114, the blockchain platform server 122, and/or the machine learning implementation processing device 132 could be combined into a single device/server. In such examples, the single device could be in communication with the resource owner processing device 108 and/or the resource requesting processing device 118 to authenticate/authorize one or more of the devices 108, 118, control access one or more of the devices 108, 118, admit one or more of the devices 108, 118 to the edge network, etc. In some examples, the proof generation circuitry 110 can be included in the resource requesting processing device 118, as further described below.

The security server 102 of FIG. 1 authenticates and/or authorizes the resource owner processing device 108 and/or the resource requesting processing device 118. The security server 102 includes the string generation circuitry 104 to generate a public string (e.g., a common reference string (CRS)) that can be distributed to the resource owner processing device 108 and the authorization server 114. In this manner, the resource owner processing device 108 can generate a proof (e.g., a Zk-SNARK proof) using the CRS and a private key and provide to the authorization server 114 to authorize the resource owner processing device 108 without accessing the private key, as further described below. Additionally, the security server 102 includes the access circuitry 106 to gather contextual data from the resource requesting processing device 118 and send the contextual data to the machine learning implementation processing device 132 to determine if the contextual data is normal or abnormal, as further described below. The access circuitry 106 can grant or revoke access of the resource requesting processing device 118 to a resource or to access to the edge network based on the machine learning model result. In this manner, the access circuitry 106 makes immediate decisions regarding access permissions of the application 120 to ensure the security and user experience of the services, resources, and/or edge network.

The resource owner processing device 108 of FIG. 1 may be a third-party entity that owns and/or controls a resource or service that can be accessed by the resource requesting processing device 118 after authentication and/or authorization. The resource owner processing device 108 may be an edge device, a microservice, a virtual execution environment, etc. A virtual execution environment may include one or more virtual machines, dockers, containers, etc. The resource owner processing device 108 includes the proof generation circuitry 110 to generate a zk-SNARK proof using an obtained CRS. For example, when a client that controls the resource owner processing device 108 wishes to authenticate, the proof generation circuitry 110 initiates the process by generating the zk-SNARK proof using the CRS from the security server 102 and a private credential (e.g., a secret key). The proof demonstrates possession of the credentials without revealing the credentials. The proof generation circuitry 110 transmits the proof to the authorization server 114 so that the authorization server 114 can authenticate the resource owner processing device 108 without revealing the secret. The resource owner processing device 108 further includes the access control circuitry 112 to grant, adjust, or revoke consent for a specific application to access service APIs, grant, adjust, or revoke access to an edge network, etc. The resource owner processing device 108 submits the adjustment of access to the blockchain platform server 122 to update a smart contract that tracks access, as further described below.

The authorization server 114 of FIG. 1 authorizes the resource owner processing device 108 by processing proofs from the resource owner processing device 108 and/or the resource requesting processing device 118. For example, the authorization server 114 uses the verification circuitry 116 to authenticate the secret within the proof using the public CRS without being able to reveal the secret. The verification circuitry 116 utilizes cryptographic computations to ensure that the proof is valid and matches the CRS without requiring access to the private credentials of the resource owner processing device 108. The authorization server 114 outputs the verification results to the resource owner processing device 108 and/or the security server 102.

The resource requesting processing device 118 of FIG. 1 is a device (e.g., a third-party device) the implements an application 120 that requests access to the edge network and/or one or more resources (e.g., one or more of a service API, a processing resource, a memory resource, a hardware resource, a software resource, etc.) of the resource owner. The application 120 may be a microservice, a virtual execution environment, a virtual machine (VM), etc. Initially, the application 120 submits a request to the resource owner processing device 108 and/or the security server 102 to access a resource. After the request, the application 120 will receive an indication of the decision to grant or restrict the requested access. In some examples, the resource requesting processing device 118 transmits contextual data to the security server 102 so that the security server 102 can use the contextual information when determining whether the grant or deny access.

In some examples, the resource requesting processing device 118 can include the proof generation circuitry 110 to authenticate itself to the security server 102, using the techniques described above. For example, if the application 120 requests access to join an edge network, the resource requesting processing device 118 can implement the proof generation circuitry 110 to submit a request to the security server 102 to join the edge network. In response to the request, the security server 102 can transmit the CRS to the resource requesting processing device 118 and the proof generation circuitry 110 of the resource requesting processing device 118 can generate a ZKP proof using the CRS and transmit to the authorization server 114 for authorization, as described above. If the authorization server 114 authorizes the application 120, the application 120 may begin to access the edge device and submit a request to the resource owner processing device 108 to access services, resources, etc. of the resource owner.

The blockchain platform server 122 of FIG. 1 is a server that deploys the smart contract 126 on a disturbed ledger stored in the memory 130 with access rules (e.g., also referred to as consent status) based on instructions from the resource owner processing device 108. The blockchain platform server 122 uses the smart contract control circuitry 124 to develop the smart contract 126 to manage consent and authorize for accessing service, resources, APIs, edge network access, etc. The smart contract includes memory 130 that stores the predefined rules and conditions that dictate how consent can be granted, adjusted or revoked by the resource owner processing device 108. After the blockchain platform server 122 deploys the smart contract 126, the smart contract becomes immutable and is accessible for resource owners processing device 108 and the application 120 to interact. When the resource owner processing device 108 uses the access control circuitry 112 to grant, adjust, or revoke consent for the application 120 to access a service, a resource, etc., the access control circuitry 112 initiate a consent transaction and transmits the consent transaction (e.g., via a user interface of the resource owner processing device 108 that interacts with the blockchain platform server 122) to the smart contract control circuitry 124 to update the distributed ledger that corresponds to the smart contract 126. For example, the smart contract control circuitry 124 interfaces with the processing circuitry 128 to cause the memory 130 to be updated to reflect the consent transaction. The smart contract control circuitry 124 can process the consent transition according to its consensus mechanism, thereby ensuring the transition is validated and security recorded on the distributed ledger (e.g., blockchain) stored in the memory 130 that reflects the contract and/or transactional history (e.g., history related to granting, denying, changing permission for one or more applications). For example, the distributed ledger stored in the memory 130 may record transactions related to the access permissions of the application 120. In some examples, the smart contract stored in the distributed ledger includes provisions for a serve level agreement (SLA) and/or a service level objective (SLO) that define performance metrics, quality of service requirements, and/or other conditions that the application 120 must adhere to while accessing the services, resource, and/or edge network.

The smart contract 126 of FIG. 1 includes processing circuitry 128 to update the distributed ledger stored in the memory 130 that reflects the contract (e.g., defining which applications have access, details related to the access, and/or which devices do not have access. The processing circuitry 128 may be logic that automatically executes in response to changes in the consent status. Thus, the processing circuitry 128 can dynamically adjust the permissions granted to the application 120 based on the updated consent status. When the smart contract control circuitry 124 detects a change to the consent status, it triggers the processing circuitry 128 executes the permission adjustment logic in real time by enabling or disabling access to certain services, service APIs, resources, etc. based on the preferences of the resource owner.

The machine learning implementation processing device 132 of FIG. 1 is a cloud or edge-based device (e.g., a computing device, a server, etc.) that implements the trained ML model 134. The ML model 134 has been trained to generate a recommendation to grant or prevent access of the application 120 to a resource based on established access patterns and behaviors. The contextual data may include the location of the resource requesting processing device 118, the timing of the access request, the security posture of the resource requesting processing device 118 (e.g., whether the device complies with current security policies), the historical behavior patterns to the resource requesting processing device 118, etc. In some examples, the ML model 134 has been trained using training data (e.g., contextual data that has been labelled with a legit device or an illegitimate device). The ML model 134 may be any type of artificial intelligence (AI)-based model (e.g., a neural network, a deep learning model, etc.). The machine learning implementation processing device 132 may obtain the contextual data in response to the application 120 requesting access to a resource. The machine learning implementation processing device 132 applies the obtained contextual data into the ML model 134 and transmits the output result to the access circuitry 106 of the security server 102.

The example network 136 of FIG. 1 is a system of interconnected systems exchanging data. The example network 136 may be implemented using any type of public or private network such as, but not limited to, the Internet, a telephone network, a cellular network, a local area network (LAN), a wide area network (WAN), mobile broadband, a 3GPP network, a cable network, and/or a wireless network. To enable communication via the network 136, the example computing devices and/or servers 102, 108, 114, 118, 122, 132 may include a communication interface that enables a connection to an Ethernet, a digital subscriber line (DSL), Fiber Optic connections, Satellite Internet, a telephone line, a coaxial cable, or any wireless connection, etc. In some examples, the example computing devices and/or servers 102, 108, 114, 118, 122, 132 are connected via the example network 136.

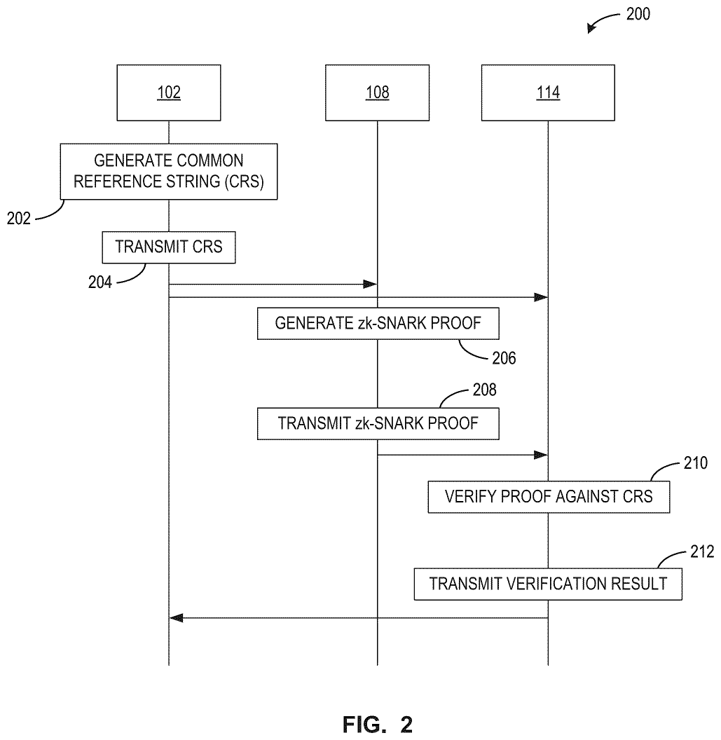

While an example manner of implementing the security server 102, the resource owner processing device 108, the authorization server 114, the resource requesting processing device 118, the blockchain platform server 122, and the machine learning implementation processing device 132 of FIG. 1 is illustrated in FIG. 1, one or more of the elements, processes, and/or devices illustrated in FIG. 1 may be combined, divided, re-arranged, omitted, eliminated, and/or implemented in any other way. Further, the string generation circuitry 104, the access circuitry 106, the proof generation circuitry 110, the access control circuitry 112, the verification circuitry 116, the application 120, the smart contract control circuitry 124, the smart contract 126, the processing circuitry 128, the memory 130, the ML model 134, and/or more generally, the security server 102, the resource owner processing device 108, the authorization server 114, the resource requesting processing device 118, the blockchain platform server 122, and the machine learning implementation processing device 132 of FIG. 1, may be implemented by hardware alone or by hardware in combination with software and/or firmware. Thus, for example, any of the string generation circuitry 104, the access circuitry 106, the proof generation circuitry 110, the access control circuitry 112, the verification circuitry 116, the application 120, the smart contract control circuitry 124, the smart contract 126, the processing circuitry 128, the memory 130, the ML model 134, and/or more generally, the security server 102, the resource owner processing device 108, the authorization server 114, the resource requesting processing device 118, the blockchain platform server 122, and the machine learning implementation processing device 132 of FIG. 1, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the security server 102, the resource owner processing device 108, the authorization server 114, the resource requesting processing device 118, the blockchain platform server 122, and the machine learning implementation processing device 132 of FIG. 1 may include one or more elements, processes, and/or devices in addition to, or instead of, those illustrated in FIGS. 2-4, and/or may include more than one of any or all of the illustrated elements, processes, and devices.

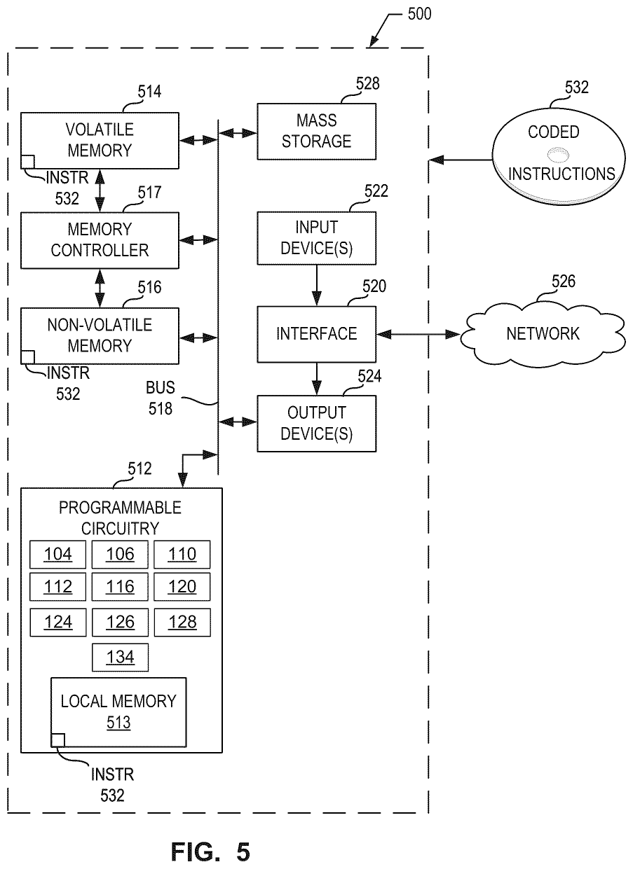

Flowchart(s) representative of example machine-readable instructions, which may be executed by programmable circuitry to implement and/or instantiate the security server 102, the resource owner processing device 108, the authorization server 114, the resource requesting processing device 118, the blockchain platform server 122, and the machine learning implementation processing device 132 of FIG. 1 and/or representative of example operations which may be performed by programmable circuitry to implement and/or instantiate the security server 102, the resource owner processing device 108, the authorization server 114, the resource requesting processing device 118, the blockchain platform server 122, and the machine learning implementation processing device 132 of FIG. 1, is shown in FIGS. FIGS. 2-4. The machine-readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2-4, many other methods of implementing the security server 102, the resource owner processing device 108, the authorization server 114, the resource requesting processing device 118, the blockchain platform server 122, and the machine learning implementation processing device 132 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, Go Lang, PyTorch, Rust, etc.

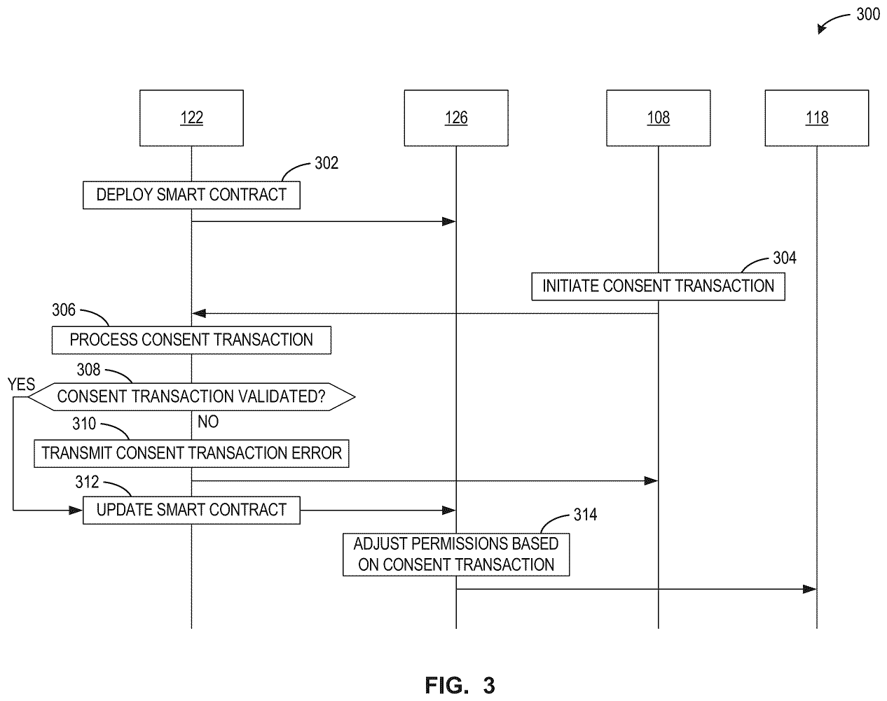

As mentioned above, the example operations of FIG. 3 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, one or more data processing units (DPUs), one or more edge processing units (EPUs), one or more infrastructure processing units (IPUs), etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 2 is a flowchart representative of example machine-readable instructions and/or example operations 300 that may be executed, instantiated, and/or performed by programmable circuitry (ies) to perform privacy-preserving authentication using Ak-SNARKs. For example, the example operations 200 may be executed, instantiated, and/or performed by at least one of the security server 102, the resource owner processing device 108, and the authorization server 114 of FIG. 1. Although FIG. 2 is described in conjunction with the authentication of the resource owner processing device 108, FIG. 2 may be described in conjunction with authorization of the resource requesting processing device 118 to join an edge network and/or access resources/services of the resource owner processing device 108. The example machine-readable instructions and/or the example operations 200 of FIG. 2 begin at block 202, at which the string generation circuitry 104 of the security server 102 generates a CRS. The CRS is a public parameter for the zk-SNARK protocol. The string generation circuitry 104 generates the CRS to not include sensitive information that could compromise the privacy and/or security of the resource owner processing device 108.

At block 204, the security server 102 transmits (e.g., deploys) the CRS to the resource owner processing device 108 and/or the authorization server 114. Sharing the CRS to devices within the network 136 of FIG. 1 ensures that both parties (e.g., the resource owner processing device 108 and the authorization server 114) have access to parameters for proof generation and verification. At block 206, the proof generation circuitry 110 of the resource owner processing device 108 generates a zk-SNARK proof using the obtained CRS and a private credential (e.g., a secret key). The zk-SNARK proof demonstrates possession of credentials without revealing them. In this manner, the resource owner processing device 108 can self-authenticate without revealing private credentials to another entity. At block 208, the resource owner processing device 108 transmits (e.g., submits, deploys, etc.) the generated zk-SNARK proof to the authorization server 114.

At block 210, the verification circuitry 116 of the authorization server 114 verifies the obtained proof from the resource owner processing device 108 against the CRS. For example, the verification circuitry 116 performs cryptographic computations to ensure that the proof is valid and matches the CRS without accessing the private materials included in the proof. At block 212, the authorization server 114 transmits a verification result to the security server 102. If the verification circuitry 116 is able to verify the proof against the CRS, the authorization server 114 transmits a verification result to the security server 102 to authenticate the resource owner processing device 108. If the verification circuitry 116 is not able to verify the proof against the CRS, the authorization server 114 transmits a signal to the security server 102 indicating that the resource owner processing device 108 has not been authenticated.

FIG. 3 is a flowchart representative of example machine-readable instructions and/or example operations 300 that may be executed, instantiated, and/or performed by programmable circuitry (ies) to manage and/or facilitate dynamic consent using smart contracts. For example, the example operations 300 may be executed, instantiated, and/or performed by at least one of the resource owner processing device 108, the resource requesting processing device 118, the blockchain platform server 122, and/or the smart contract 126 of FIG. 1. The example machine-readable instructions and/or the example operations 300 of FIG. 3 begin at block 302, at which the smart contract control circuitry 124 of the blockchain platform server 122 deploys the smart contract 126. As described above, the smart contract 126 is developed to manage consent and authorization for accessing services, resources, service APIs, access to edge, etc. The smart contract 126 may include predefined rules and/or conditions that dictate how consent can be granted, adjusted, or revoked by the resource owner processing device 108. After the smart contract 126 is deployed, the smart contract 126 becomes immutable and is accessible for the resource owner processing device 108 and the application 120 to interact.

At block 304, the resource owner processing device 108 initiates a consent transaction to grant, adjust, or revoke content for the application 120 to access the services, service APIs, resources, and/or access. For example, a user may interact with a user interface of the resource owner processing device 108 which interacts with the blockchain platform server 122 to initiate the consent transaction. The consent transition is transmitted (e.g., submitted, deployed, etc.) to the blockchain platform server 122. At block 306, the smart contract control circuitry 124 processes the consent transaction according to a consensus mechanism to ensure the transaction is validated and securely recorded on the ledger stored in the memory 130 of the smart contract 126. If the smart contract control circuitry 124 does not validate the consent transaction (block 310: NO), the blockchain platform server 122 transmits a consent transaction error to the resource owner processing device 108 (block 310). If the smart contract control circuitry 124 validates the consent transaction (block 308: YES), the processing circuitry 128 of the smart contract 126 updates the smart contract's state on the ledger stored in the memory 130 to reflect the new consent status (block 312).

At block 314, the processing circuitry 128 of the smart contract 126 adjusts the permissions based on the validated consent transaction. For example, the processing circuitry 128 can modify permissions associated with eh application 120 as directed by the resource owner processing device 108. The processing circuitry 128 automatically executes in response to changes in the consent status by dynamically, and/or in real-time, adjusting the permission grated to the application 120 based on the updated consent status. For example, the processing circuitry 128 can enable or disable access to particular service, resource, etc. based on the preferences of the resource owner utilizing the resource owner processing device 108.

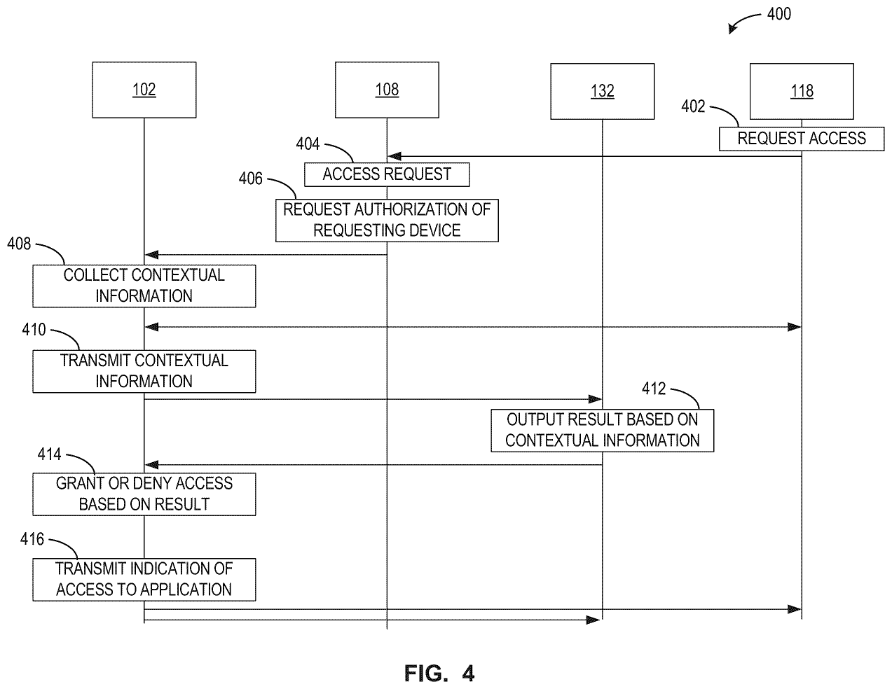

FIG. 4 is a flowchart representative of example machine-readable instructions and/or example operations 300 that may be executed, instantiated, and/or performed by programmable circuitry (ies) to implement a context-aware dynamic access control system (CADACS). For example, the example operations 400 may be executed, instantiated, and/or performed by at least one of the security server 102, the resource owner processing device 108, and the resource requesting processing device 118, and/or the machine learning implementation processing device 132 of FIG. 1. The example machine-readable instructions and/or the example operations 400 of FIG. 4 begin at block 402, at which the application 120 of the resource requesting processing device 118 requests access to a service, API service, a resource, access to a network, etc.

At block 404, the access control circuitry 112 accesses (e.g., receives, obtains, etc.) the request from the resource requesting processing device 118. At block 406, the access control circuitry 112 requests the security server 102 to authorize the resource requesting processing device 118. At block 408, after the security server 102 obtains the request to authorize and/or authenticate the application 120, the access circuitry 106 of the security server 102 collects contextual information. For example, the access circuitry 106 can request contextual information from the resource requesting processing device 118 and/or may utilize previously obtained contextual information related to the resource requesting processing device 118.

At block 410, the security server 102 transmits the collected contextual information to the machine learning implementation processing device 132. At block 412, the machine learning implementation processing device 132 inputs the contextual information into the ML model 134 to output a result based on the contextual information. As further described above in conjunction with FIG. 1, the ML model 134 has been trained to output a result that corresponds to a valid device or an invalid device based on contextual information. The machine learning implementation processing device 132 transmits the results back to the security server 102.

At block 414, the access circuitry 106 grants or denies access to the requested service, API, resource, etc. based on the result of the ML model 134. At block 416, the security server 102 transmits an indication of access to the application 120 to the resource requesting processing device 118 and/or the resource owner processing device 108. In this manner, the application 120 can be aware of whether access was granted or denied and the resource owner processing device 108 can grant or deny access to the service, API service, resource, etc. based on the indication from the access circuitry 106 of the security server 102.

FIG. 5 is a block diagram of an example programmable circuitry platform 500 structured to execute and/or instantiate the example machine-readable instructions and/or the example operations of FIGS. 2-4 to implement at least one of the security server 102, the resource owner processing device 108, the authorization server 114, the resource requesting processing device 118, the blockchain platform server 122, and/or the machine learning implementation processing device 132 of FIG. 1. The programmable circuitry platform 500 can be, for example, a server, a personal computer, a workstation, a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, DPUs, EPUs, IPUs and/or microcontrollers from any desired family or manufacturer. The programmable circuitry 512 may be implemented by one or more semiconductor based (e.g., silicon based) devices. In this example, the programmable circuitry 512 can implement any one or more of the string generation circuitry 104, the access circuitry 106, the proof generation circuitry 110, the access control circuitry 112, the verification circuitry 116, the application 120, the smart contract control circuitry 124, the smart contract 126, the processing circuitry 128, and/or the ML model 134 of FIG. 1.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), High Bandwidth Memory (HBM), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516. Any one or more of the main memory 514, 516 or the local memory 513 can implement one or more of the memory 130 of FIG. 1.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, a keyboard, a button, a mouse, and/or a touchscreen.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The network 526 may be the network 136 of FIG. 1. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 532, which may be implemented by the machine-readable instructions of FIGS. 2-4, may be stored in the mass storage device 528, in the volatile memory 514, in the non-volatile memory 516, and/or on at least one non-transitory computer readable storage medium such as a CD or DVD which may be removable.

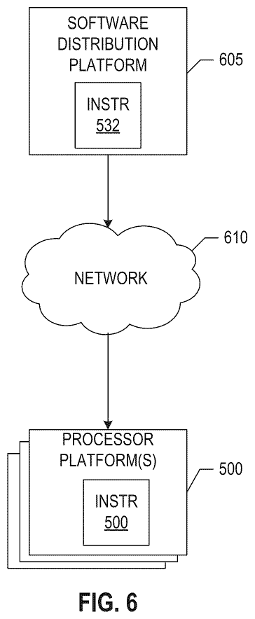

A block diagram illustrating an example software distribution platform 605 to distribute software such as the example machine-readable instructions 532 of FIG. 5 to other hardware devices (e.g., hardware devices owned and/or operated by third parties from the owner and/or operator of the software distribution platform) is illustrated in FIG. 6. The example software distribution platform 605 may be implemented by any computer server, data facility, cloud service, etc., capable of storing and transmitting software to other computing devices. The third parties may be customers of the entity owning and/or operating the software distribution platform 605. For example, the entity that owns and/or operates the software distribution platform 605 may be a developer, a seller, and/or a licensor of software such as the example machine-readable instructions 532 of FIG. 5. The third parties may be consumers, users, retailers, OEMs, etc., who purchase and/or license the software for use and/or re-sale and/or sub-licensing. In the illustrated example, the software distribution platform 605 includes one or more servers and one or more storage devices. The storage devices store the machine-readable instructions 532, which may correspond to the example machine-readable instructions of FIG. 3, as described above. The one or more servers of the example software distribution platform 605 are in communication with an example network 610, which may correspond to the network 136 of FIG. 1. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 532 from the software distribution platform 605. For example, the software, which may correspond to the example machine-readable instructions of FIG. 3, may be downloaded to the example programmable circuitry platform 500 which is to execute the machine-readable instructions 532 to implement the processor circuitry 512. In some examples, one or more servers of the software distribution platform 605 periodically offer, transmit, and/or force updates to the software (e.g., the example machine-readable instructions 532 of FIG. 5) to ensure improvements, patches, updates, etc., are distributed and applied to the software at the end user devices. Although referred to as software above, the distributed “software” could alternatively be firmware.

Example methods, apparatus, systems, and articles of manufacture to manage configuration assets for network devices are disclosed herein. Further examples and combinations thereof include the following:
Example 1 includes a method for securely admitting a third-party entity, including an application, a microservice, or a virtual execution environment, a virtual machine (VM), to an edge network, the method comprising based on a request from the third-party entity to join the edge network, initiating a Zero-Knowledge Proof (ZKP) protocol by generating a common reference string (CRS) to establish public parameters within the edge network, transmitting the CRS to the third-party entity and an authorization server, obtaining an authorization of the third-party entity from the authorization server, the authorization server authenticating the third-party entity based on a ZKP proof constructed by the third-party entity using the CRS and a private credential of the third-party entity, authorizing the third-party entity to join the edge network based on the authorization, and deploying a smart contract on a distributed ledger, wherein the smart contract specifies conditions under which the third-party entity is granted access to the edge network, and wherein the distributed ledger records transactions related to access permissions of the third-party entity.
Example 2 includes the method of example 1, wherein the distributed ledger is a blockchain providing a transparent record of all smart contract transactions and consent changes related to access to services by the third-party entity in the edge network.
Example 3 includes the method of example 2, wherein the blockchain serves as an immutable record for a state of the smart contract and consent transactions.
Example 4 includes the method of any one of examples 1-3, wherein the smart contract includes provisions for at least one of a service level agreement (SLA) or a service level objective (SLO), the at least one of the SLA or the SLO defining performance metrics, quality of service requirements, and other conditions for the third-party entity to adhere to while accessing the edge network.
Example 5 includes the method of any one of examples 1-4, further including utilizing the smart contract to dynamically modify the access permissions of the third-party entity based on a consent transaction that is recorded on the distributed ledger.
Example 6 includes the method of example 5, wherein the consent transaction is initiated by a resource owner to grant, modify, or revoke access of the third-party entity to a particular service within the edge network.
Example 7 includes the method of any one of examples 1-6, further including implementing a Context-Aware Dynamic Access Control System (CADACS) that employs a machine learning algorithm to evaluate contextual data related to access requests from the third-party entity.
Example 8 includes the method of example 7, further including implementing the CADACS to adjust the access permissions of the third-party entity based on an assessment of the contextual data against established access patterns and behaviors.
Example 9 includes the method of example 8, further including implementing the CADACS to make immediate decisions regarding the access permissions of the third-party entity to ensure the security and user experience of the edge network.
Example 10 includes the method of example 9, wherein the contextual data includes at least one of a location of the third-party entity, a timing of the access permissions, security status of the third-party entity, or historical behavior patterns.
Example 11 includes an apparatus comprising interface circuitry to obtain a configuration request, machine readable instructions, and at least one programmable circuit to at least one of instantiate or execute the machine readable instructions to, based on a request from a third-party entity to join an edge network, initiate a Zero-Knowledge Proof (ZKP) protocol by generating a common reference string (CRS) to establish public parameters within the edge network, transmit the CRS to the third-party entity and an authorization server, obtain an authorization of the third-party entity from the authorization server, the authorization server authenticating the third-party entity based on a ZKP proof constructed by the third-party entity using the CRS and a private credential of the third-party entity, authorize the third-party entity to join the edge network based on the authorization, and deploy a smart contract on a distributed ledger, wherein the smart contract specifies conditions under which the third-party entity is granted access to the edge network, and wherein the distributed ledger records transactions related to access permissions of the third-party entity.
Example 12 includes the apparatus of example 11, wherein the distributed ledger is a blockchain providing a transparent record of all smart contract transactions and consent changes related to access to services by the third-party entity in the edge network.
Example 13 includes the apparatus of example 12, wherein the blockchain serves as an immutable record for a state of the smart contract and consent transactions.
Example 14 includes the apparatus of any one of examples 11-13, wherein the smart contract includes provisions for at least one of a service level agreement (SLA) or a service level objective (SLO), the at least one of the SLA or the SLO defining performance metrics, quality of service requirements, and other conditions for the third-party entity to adhere to while accessing the edge network.
Example 15 includes the apparatus of any one of examples 11-14, wherein the at least one programmable circuit is to use the smart contract to dynamically modify the access permissions of the third-party entity based on a consent transaction that is recorded on the distributed ledger.
Example 16 includes the apparatus of example 15, wherein the consent transaction is initiated by a resource owner to grant, modify, or revoke access of the third-party entity to a particular service within the edge network.
Example 17 includes the apparatus of any one of examples 11-16, wherein the at least one programmable circuit is to employ a machine learning algorithm to evaluate contextual data related to access requests from the third-party entity.
Example 18 includes the apparatus of example 17, wherein the at least one programmable circuit is to adjust the access permissions of the third-party entity based on an assessment of the contextual data against established access patterns and behaviors.
Example 19 includes the apparatus of example 18, wherein the at least one programmable circuit is to make immediate decisions regarding the access permissions of the third-party entity to ensure security and user experience of the edge network.
Example 20 includes a non-transitory computer readable medium comprising instructions to cause at least one programmable circuit to, based on a request from a third-party entity to join an edge network, initiate a Zero-Knowledge Proof (ZKP) protocol by generating a common reference string (CRS) to establish public parameters within the edge network, cause transmission of the CRS to the third-party entity and an authorization server, obtain an authorization of the third-party entity from the authorization server, the authorization server authenticating the third-party entity based on a ZKP proof constructed by the third-party entity using the CRS and a private credential of the third-party entity, authorize the third-party entity to join the edge network based on the authorization, and cause deployment of a smart contract on a distributed ledger, wherein the smart contract specifies conditions under which the third-party entity is granted access to the edge network, and wherein the distributed ledger records transactions related to access permissions of the third-party entity.

From the foregoing, it will be appreciated that example systems, apparatus, articles of manufacture, and methods have been disclosed to manage configuration assets for network devices. Examples disclosed herein create an enhanced authentication and authorization system capable of distinguishing between client (REST client) and resource owners, dynamically manage access permissions, and securely handle consent in edge computing environments. Examples disclosed herein provide secure access to applications and/or data of a resource owner to requesting devices in the edge environment, which varies depending on contextual factors such as the user's location, time of access, security posture of the user's device, and observed user behavior. Thus, disclosed example systems, apparatus, articles of manufacture, and methods are directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method for securely admitting a third-party entity, including an application, a microservice, or a virtual execution environment, to an edge network, the method comprising:
based on a request from the third-party entity to join the edge network, initiating a Zero-Knowledge Proof (ZKP) protocol by generating a common reference string (CRS) to establish public parameters within the edge network;
transmitting the CRS to the third-party entity and an authorization server;
obtaining an authorization of the third-party entity from the authorization server, the authorization server authenticating the third-party entity based on a ZKP proof constructed by the third-party entity using the CRS and a private credential of the third-party entity;
authorizing the third-party entity to join the edge network based on the authorization; and
deploying a smart contract on a distributed ledger, wherein the smart contract specifies conditions under which the third-party entity is granted access to the edge network, and wherein the distributed ledger records transactions related to access permissions of the third-party entity.

2. The method of claim 1, wherein the distributed ledger is a blockchain providing a transparent record of all smart contract transactions and consent changes related to access to services by the third-party entity in the edge network.

3. The method of claim 2, wherein the blockchain serves as an immutable record for a state of the smart contract and consent transactions.

4. The method of claim 1, wherein the smart contract includes provisions for at least one of a service level agreement (SLA) or a service level objective (SLO), the at least one of the SLA or the SLO defining performance metrics, quality of service requirements, and other conditions for the third-party entity to adhere to while accessing the edge network.

5. The method of claim 1, further including utilizing the smart contract to dynamically modify the access permissions of the third-party entity based on a consent transaction that is recorded on the distributed ledger.

6. The method of claim 5, wherein the consent transaction is initiated by a resource owner to grant, modify, or revoke access of the third-party entity to a particular service within the edge network.

7. The method of claim 1, further including implementing a Context-Aware Dynamic Access Control System (CADACS) that employs a machine learning algorithm to evaluate contextual data related to access requests from the third-party entity.

8. The method of claim 7, further including implementing the CADACS to adjust the access permissions of the third-party entity based on an assessment of the contextual data against established access patterns and behaviors.

9. The method of claim 8, further including implementing the CADACS to make immediate decisions regarding the access permissions of the third-party entity to ensure the security and user experience of the edge network.

10. The method of claim 9, wherein the contextual data includes at least one of a location of the third-party entity, a timing of the access permissions, security status of the third-party entity, or historical behavior patterns.

11. An apparatus comprising:
interface circuitry to obtain a configuration request;
machine readable instructions; and
at least one programmable circuit to at least one of instantiate or execute the machine readable instructions to:
based on a request from a third-party entity to join an edge network, initiate a Zero-Knowledge Proof (ZKP) protocol by generating a common reference string (CRS) to establish public parameters within the edge network;
transmit the CRS to the third-party entity and an authorization server;
obtain an authorization of the third-party entity from the authorization server, the authorization server authenticating the third-party entity based on a ZKP proof constructed by the third-party entity using the CRS and a private credential of the third-party entity;
authorize the third-party entity to join the edge network based on the authorization; and
deploy a smart contract on a distributed ledger, wherein the smart contract specifies conditions under which the third-party entity is granted access to the edge network, and wherein the distributed ledger records transactions related to access permissions of the third-party entity.

12. The apparatus of claim 11, wherein the distributed ledger is a blockchain providing a transparent record of all smart contract transactions and consent changes related to access to services by the third-party entity in the edge network.

13. The apparatus of claim 12, wherein the blockchain serves as an immutable record for a state of the smart contract and consent transactions.

14. The apparatus of claim 11, wherein the smart contract includes provisions for at least one of a service level agreement (SLA) or a service level objective (SLO), the at least one of the SLA or the SLO defining performance metrics, quality of service requirements, and other conditions for the third-party entity to adhere to while accessing the edge network.

15. The apparatus of claim 11, wherein the at least one programmable circuit is to use the smart contract to dynamically modify the access permissions of the third-party entity based on a consent transaction that is recorded on the distributed ledger.

16. The apparatus of claim 15, wherein the consent transaction is initiated by a resource owner to grant, modify, or revoke access of the third-party entity to a particular service within the edge network.

17. The apparatus of claim 11, wherein the at least one programmable circuit is to employ a machine learning algorithm to evaluate contextual data related to access requests from the third-party entity.

18. The apparatus of claim 17, wherein the at least one programmable circuit is to adjust the access permissions of the third-party entity based on an assessment of the contextual data against established access patterns and behaviors.

19. The apparatus of claim 18, wherein the at least one programmable circuit is to make immediate decisions regarding the access permissions of the third-party entity to ensure security and user experience of the edge network.

20. A non-transitory computer readable medium comprising instructions to cause at least one programmable circuit to:
based on a request from a third-party entity to join an edge network, initiate a Zero-Knowledge Proof (ZKP) protocol by generating a common reference string (CRS) to establish public parameters within the edge network;
cause transmission of the CRS to the third-party entity and an authorization server;
obtain an authorization of the third-party entity from the authorization server, the authorization server authenticating the third-party entity based on a ZKP proof constructed by the third-party entity using the CRS and a private credential of the third-party entity;
authorize the third-party entity to join the edge network based on the authorization; and
cause deployment of a smart contract on a distributed ledger, wherein the smart contract specifies conditions under which the third-party entity is granted access to the edge network, and wherein the distributed ledger records transactions related to access permissions of the third-party entity.
